(19) United States
(12) Patent Application Publication
(10) Pub. No.: US 2018/0292429 A1
(43) Pub. Date: Oct. 11, 2018

(54) High Precision Trajectory and Speed Sensor and Measuring Method

(71) Applicant: ECOLE POLYTECHNIQUE FEDERALE DE LAUSANNE (EPFL), Lausanne (CH)

(72) Inventors: Benedikt Fasel, Chavannes-près-Renens (CH); Kamiar Aminian, La Tour-de-Peilz (CH)

(21) Appl. No.: 15/569,386

(22) PCT Filed: Apr. 28, 2016
(86) PCT No.: PCT/IB2016/052419

§ 371 Date: Oct. 26, 2017

(30) Foreign Application Priority Data
Apr. 28, 2015 (IB) PCT/IB2015/053086

(51) Int. Cl. G01P 3/50; A63B 69/18; A63B 71/06; A63B 71/12; G01P 15/18; G01P 15/16; G01P 15/14

(52) U.S. Cl. CPC G01P 3/50; A63B 2244/19; A63B 71/0616; A63B 71/12; G01P 15/18; G01P 15/165; G01P 15/14; A63B 2225/50; A63B 2071/0691; A63B 2209/08; A63B 2220/12; A63B 2220/36; A63B 2220/34; A63B 2220/44; A63B 2220/836; A63B 69/18

(57) ABSTRACT

A method for contactlessly determining an exact passage of an athlete at points placed along a track in sports, wherein the method comprises gearing the athlete with a wearable magnetometer sensor unit, whereby the magnetometer sensor unit is equipped with at least a magnetic sensor, a processing unit, and a storage medium; placing at each point at least a permanent magnet in proximity of a track surface of the track. When the athlete moves along the track, the method further comprises recording at the magnetic sensor a signal; detecting for each permanent magnet a disturbance of a local magnetic field generated by the permanent magnet in the recorded signal and measuring the disturbance; mapping of the measured disturbance to a movement speed of the athlete and a distance of the athlete to the magnet corresponding to the local magnetic field; and correcting the movement speed and the distance for a time offset between the magnet passage of an athlete's center of mass and the magnetometer sensor unit.

### TECHNICAL FIELD

The present invention relates to a timing system, and in a preferred embodiment also to a timing and motion tracking system. More particularly the invention's timing and/or tracking system is for use in alpine ski racing.

### BACKGROUND

In alpine ski racing performance is measured as the time from start to finish of a run. In order to provide useful feedback to athletes, coaches usually analyze key sections of the run.

Currently, standard video analysis is used as the main mean of feedback to the athletes. Using dedicated video analysis software (e.g., Dartfish, Switzerland), different runs can be manually synchronized and compared to each other. Although video feedback is crucial, the current analysis procedure is time consuming and provides no information with respect to instantaneous skiing speed, for example. Moreover, video analysis provides only limited possibilities for obtaining precise timing information, for example for gate-to-gate timing.

A system measuring automatically gate-to-gate timing would therefore be a great plus. It would provide precise information between which gates time was lost or gained. During training such information could be transferred to coaches for a better feedback to athletes. During races such information could be transferred directly to the television broadcast service for a better feedback to spectators.

For a successful performance analysis, it is important to know the precise instantaneous skiing speed of the athlete's center of mass (CoM) and to relate any speed gain or loss to the athlete's movement. For example, a speed loss due to a small error may not be relevant immediately when the error happened but the effect may induce a large time loss only after a few gates. In another example, the effect of choosing two different skiing trajectories may result in a large time difference only after a few gates. For both examples, in order to explain this time difference and its origin, the skiing trajectory and speed need to be known with great precision.

Differential Global Navigation Satellite System (GNSS) may be used for providing speed and trajectory data with sufficient precision [Gilgien, M., Sporn, J., Limpach, P., Geiger, A., & Müller, E. (2014). The effect of different Global Navigation Satellite System methods on positioning accuracy in elite alpine skiing. Sensors (Basel, Switzerland), 14(10), 18433-53]. The GNSS only returns the speed and position measured at the antenna, usually fixed to the athlete's helmet or upper back. Thus, the speed and trajectory of the athlete's CoM cannot be measured directly. Especially the athlete's pendular movements during the turns may result in large speed and trajectory differences between the speed and trajectory measured with the GNSS antenna and the athlete's true CoM speed and trajectory. Thus, other systems were proposed where GNSS information was fused with information obtained by inertial sensors placed on the body [Brodie, M., Walmsley, A., & Page, W. (2008). Fusion motion capture: a prototype system using inertial measurement units and GPS for the biomechanical analysis of ski racing. Sports Technology, 1(1), 17-28], [Supej, M. (2010). 3D measurements of alpine skiing with an inertial sensor motion capture suit and GNSS RTK system. Journal of Sports Sciences, 28(7), 759-69]. With respect to a timing application it was demonstrated that differential GNSS may be used for measuring gate-to-gate times and using this information for performance analysis [Supej, M. (2011). A New Time Measurement Method Using a High-End Global Navigation Satellite System to Analyze Alpine Skiing. Research Quarterly for Exercise and Sport, 82(3)]. Another major drawback of the differential GNSS is its complex setup: additional fixed ground stations are required, gate positions need to be surveyed, and the instrumentation is rather heavy, often requiring wearing a backpack. Such a system fails to meet the requirements of easy handling and uncomplicated use needed for a training application.

### SUMMARY OF INVENTION

In a first aspect the invention provides a method for contactlessly determining an exact passage of an athlete at points placed along a track in sports, wherein the method comprises gearing the athlete with a wearable magnetometer sensor unit, whereby the magnetometer sensor unit is equipped with at least a magnetic sensor, a processing unit, and a storage medium; placing at each point at least a permanent magnet in proximity of a track surface of the track. When the athlete moves along the track, the method further comprises recording at the magnetic sensor a signal; detecting for each permanent magnet a disturbance of a local magnetic field generated by the permanent magnet in the recorded signal and measuring the disturbance; mapping of the measured disturbance to a movement speed of the athlete and a distance of the athlete to the magnet corresponding to the local magnetic field; and correcting the movement speed and the distance for a time offset between the magnet passage of an athlete's center of mass and the magnetometer sensor unit.

In a preferred embodiment the magnetometer sensor unit is fixed to the athlete's trunk and further comprises a 3D accelerometer and 3D gyroscope. The method comprises measuring 3D accelerations and 3D angular velocities at the magnetometer sensor unit; computing a trunk orientation based on the measured 3D accelerations and 3D angular velocities; and using the trunk orientation to report the measured 3D acceleration and 3D angular velocities in a global reference frame, to remove Earth gravity from the measured acceleration, and to estimate a turn radius and to provide means to express the measured quantities along the trajectory frame.

In a preferred embodiment the 3D acceleration is integrated to obtain speed and a speed drift is corrected based on estimated speeds at point passage and at beginning and end of race.

In a preferred embodiment the speed is integrated to obtain the movement trajectory.

In a preferred embodiment the permanent magnets are placed at gates along a skiing race track on snow, whereby each permanent magnet is integrated in a pole of the respective gates.

In a preferred embodiment the permanent magnets are placed at gates along a skiing race track on snow, whereby each permanent magnet is buried in the snow.

In a preferred embodiment the permanent magnets are placed at regular intervals along a marked line on the race track.

In a preferred embodiment the magnetic strength of a permanent magnet is increased by aligning at least two smaller permanent magnets spaced apart by iron yokes or a non-magnetic spacing material such as plastic or wood.

In a preferred embodiment the magnetometer sensor unit further comprises means of communication for transmitting recorded data wirelessly to a base station.

In a second aspect the invention provides a method for determining a skiing trajectory of an athlete in sports where the skiing trajectory is defined as a trajectory of the athlete's center of mass, whereby the athlete wears an instrumented back protector. The back protector comprises an active Global Navigation Satellite System (GNSS) antenna, whereby the antenna is located in the back protector in such a manner that it is located between the shoulder blades of the athlete at a time when the back protector is worn; and a GNSS sensor unit comprising a global navigation satellite system receiver, an inertial sensor unit with 3D accelerometers and 3D gyroscopes, a processing unit, and a storage medium. The method comprises computing a trunk orientation based on measured 3D accelerations and 3D angular velocities; translating the measured 3D accelerations and 3D angular velocities to a GNSS antenna position and expressing them in a global reference frame; removing the Earth gravity from the measured acceleration to obtain inertial measurement unit-derived antenna kinematics; fusing the inertial measurement unit-derived antenna kinematics with navigation information from the GNSS receiver to obtain the final antenna kinematics, including at least one of the list comprising acceleration, speed, position, angular velocity, orientation; and translating the antenna kinematics to the athlete's center of mass to obtain the final center of mass kinematics.

In a preferred embodiment the athlete further wears a magnetometer sensor unit, whereby the magnetometer sensor unit is equipped with at least a magnetic sensor. The method further comprises adding a synchronization module to the GNSS sensor unit to achieve a sample-by-sample electronic and automatic synchronization between the GNSS sensor unit and the magnetometer sensor unit, whereby one unit acts as a master unit and emits a synchronization signal in regular intervals, the synchronization signal being received, processed and recorded by the other unit acting as a slave unit, thereby allowing the slave unit to align its internal clock with the master unit.

In a preferred embodiment the method further comprises translating the measured inertial data of any one of the GNSS sensor unit and the magnetometer sensor unit to the other sensor unit; comparing inertial data from each sensor unit in a common reference frame thereby determining differences; relating the differences to orientation estimation drift; and, correcting orientation estimation drift in both sensor units in a recursive or iterative manner.

In a preferred embodiment, the method further comprises improving a precision of the skiing trajectory estimated with the GNSS system, thereby estimating a magnet position of each passed permanent magnet, comparing the estimated magnet positions with the true magnet positions, obtaining an initial trajectory estimation error for each magnet, from a result of the comparing, and interpolating between each estimation error and subtraction of an error curve from the initial trajectory estimation, thereby obtaining the precision improved skiing trajectory estimation.

In a preferred embodiment true magnet positions of the permanent magnets are estimated based on averaging estimated magnet position from a plurality of passages, by the same or different athletes.

In a preferred embodiment the GNSS sensor unit further comprises means of communication for transmitting recorded data wirelessly to a base station.

In a third aspect the invention provides a system configured to contactlessly determine an exact passage of an athlete at points placed along a track in sports. The system comprises a gearing intended to be worn by the athlete, comprising a wearable magnetometer sensor unit, whereby the magnetometer sensor unit is equipped with at least a magnetic sensor, a processing unit, and a storage medium; for each point, at least a permanent magnet placed in proximity of a track surface of the track. The magnetometer sensor unit is configured to record a signal when the athlete moves along the track, thereby detecting for each permanent magnet a disturbance of a local magnetic field generated by the permanent magnet in the recorded signal and measuring the disturbance, the storage medium being configured to store the measured signal. The system further comprises mapping means configured for mapping of the measured disturbance to a movement speed of the athlete and a distance of the athlete to the magnet corresponding to the local magnetic field; and correcting means configured for correcting the movement speed and the distance for a time offset between the magnet passage of an athlete's center of mass (50) and the magnetometer sensor unit.

In a preferred embodiment the magnetometer sensor unit further comprises a 3D accelerometer and 3D gyroscope, wherein the magnetometer sensor unit is further configured to measure 3D accelerations and 3D angular velocities; trunk orientation computing means configured for computing a trunk orientation based on the measured 3D accelerations and 3D angular velocities. The trunk orientation computing means is further configured to use the trunk orientation to report the measured 3D acceleration and 3D angular velocities in a global reference frame, to remove Earth gravity from the measured acceleration, and to estimate a turn radius and to provide means to express the measured quantities along the trajectory frame.

In a preferred embodiment the processing unit (7) is configured to perform functions of any one of the mapping means, the correction means and the trunk orientation computation means.

In a preferred embodiment, the system further comprises a computer distinct from the gearing, the computer being configured to receive and read from the storage medium, and perform functions of any one of the mapping means, the correction means and the trunk orientation computation means.

The invention enables a system based on standard GNSS—i.e., no ground stations are required—, inertial sensors and magnetic sensors. The system provides accurate and precise information relevant to the performance in alpine ski racing such as skiing speed and trajectory of the athlete's center of mass and gate-to-gate timing.

An other application of the inventive system is for augmented feedback to TV spectators. Before a race, the entire run is scanned by a drone or a helicopter and the terrain reconstructed in 3D. Thus, skiing performance and gate-to-gate timing may be superposed on the 3D terrain model and shown to the spectator in a visually appealing and intuitive way. Time loss, time gain as well as skiing trajectory information may be displayed in 3D and performance between skiers analyzed with a higher resolution and for sections where no cameras were covering the run.

### BRIEF DESCRIPTION OF THE DRAWINGS

The invention will be better understood through the description of preferred embodiments and in view of the figures, wherein

FIG. 1 shows an example placement of the magnetic sensor unit to the sacrum of the athlete;

FIG. 2 shows an integration of the magnetic sensor unit in equipment, where in (A) the sensor is integrated in the back protector and in (B) the sensor is integrated in the kidney belt;

FIG. 3 shows a detailed example embodiment of the components of the magnetometer sensor unit;

FIG. 4 shows an example illustration of a permanent magnet;

FIG. 5 contains an illustrative example of permanent magnets placed at each gate on a ski slope, wherein the magnet's south pole is pointed towards the top, in line with an example embodiment of the invention;

FIG. 6 illustrates an example of measured magnetic field intensity during a gate crossing according to an example embodiment of the invention;

FIG. 7 illustrates changes of measured magnetic field intensity shape depending on the skier's speed and his closest distance to the gate;

FIG. 8 illustrates a fitted curve to the measured magnetic field intensity;

FIG. 9 is a schematic illustration where fitted curve peak height and peak width are used to estimate skiing speed and closest distance to the gate during gate passage;

FIG. 10 is a schematic illustration of magnetic field measurement at a time where an athlete's center of mass is passing a gate, according to an example embodiment of the invention;

FIG. 11 is a schematic illustration of the relation between estimated speed and the delay between athlete's center of mass gate passage and magnetic sensor gate passage;

FIG. 12 defines the different frames used;

FIG. 13 illustrates the strapdown integration for finding the athlete's lower trunk orientation;

FIG. 14 defines the turn frames and turn radius;

FIG. 15 shows a back view of an instrumented back protector according to an example embodiment of the invention with the GNSS sensor unit;

FIG. 16 shows a detailed example embodiment of the components of the GNSS sensor unit

FIG. 17 is a side view of the back protector with the estimated position of the athlete's center of mass, according to an example embodiment of the invention;

FIG. 18 illustrates the differences between athlete center of mass trajectory and GNSS antenna trajectory;

FIG. 19 is a schematic illustration explaining the estimation of the athlete center of mass trajectory;

FIG. 20 illustrates the differences between the true and estimated skiing trajectory;

FIG. 21 illustrates an example embodiment where the back protector is instrumented with a GNSS sensor and antenna and a magnetometer sensor unit;

FIG. 22 shows a detailed example embodiment of the components of the GNSS and magnetometer sensor units allowing them to measure synchronized;

FIG. 23 is a schematic illustration explaining the sensor drift correction method;

FIG. 24 illustrates the differences between estimated gate passage, magnet position and true gate passage and magnet position;

FIG. 25 illustrates a preferred embodiment for correcting trajectory errors;

FIG. 26 illustrates how the true magnet positions are estimated;

FIG. 27 illustrates the speed drift correction method;

FIG. 28 illustrates placing the magnetic sensors on at least one shank; and

FIG. 29 illustrates a straight skiing setup.

### DESCRIPTION OF DETAILED EMBODIMENTS OF THE INVENTION

A typical example of the invention will now be described by referencing the figures.

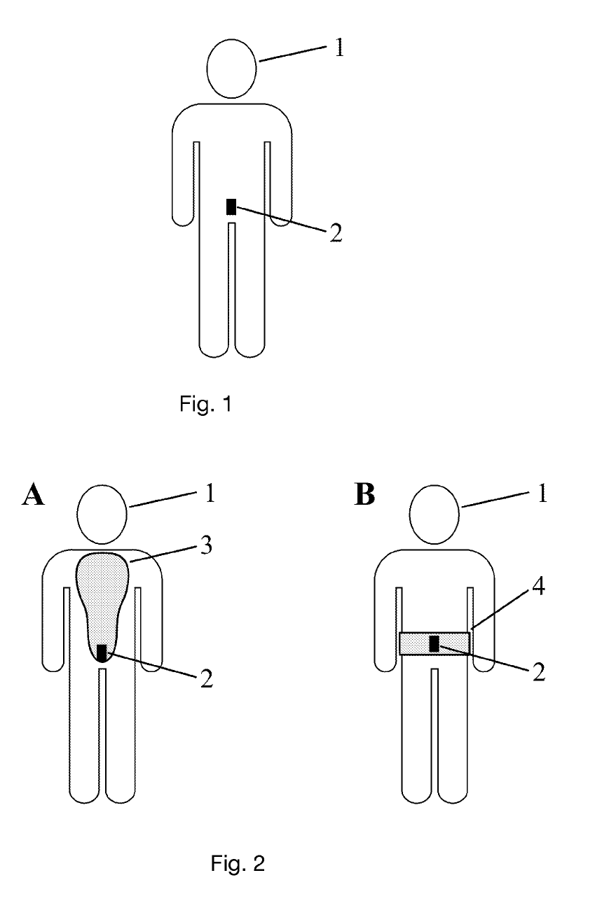

Referring to FIG. 1, in a preferred embodiment of the invention a magnetometer sensor unit 2 is attached to the athlete 1 using adhesive tape. The magnetometer sensor unit 2 is attached closely to the sacrum of the athlete 1, on his lower back.

Referring to FIG. 2A, in another preferred embodiment of the invention the magnetometer sensor unit 2 is integrated in a back protector 3, for example a standard protector complying to the rules of the Federation Internationale de Ski (F.I.S.). Referring to FIG. 2B, in another preferred embodiment of the invention the magnetometer sensor unit 2 is integrated into a kidney belt 4.

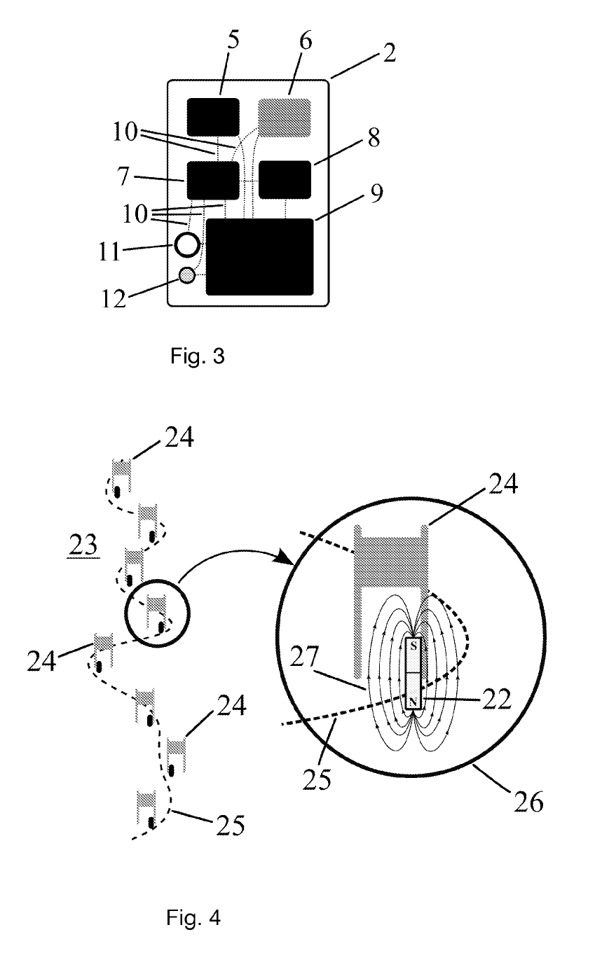

Referring to FIG. 3, this illustrates an example embodiment of the magnetometer sensor unit 2 comprising of a high performance 3D magnetic sensor 5 capable of sampling at least at 50 Hz. In an example embodiment this may be for example a Melexis MLX90393 sampling at 125 Hz. The magnetometer sensor unit 2 may comprise further an inertial measurement unit 6 (3D accelerometers and 3D gyroscopes), a processing unit 7, a storage medium 8 and a power supply such as a battery 9. The inertial measurement unit 6 is entirely optional and is used in one embodiment of the present invention for improved parameter computations. A preferred sampling frequency of the inertial measurement unit 6 is 500 Hz. The different units are suitably connected by wires 10. An on/off button 11 allows to control switch on and off the magnetometer sensor unit 2. A light emitting diode (LED) 12 is further used for visual feedback of good functioning of the magnetometer sensor unit 2. In an example embodiment the LED is blinking green if it is switched on and measuring correctly and blinking red if there is any problem with data recording, sensors, or battery level.

In a preferred embodiment all the data processing explained further is performed on the processing unit 7, either in real time or in post processing mode once the athlete reached the finish. In a further preferred embodiment all the sensor data is stored on the storage medium 8. At the end of the race the data is transmitted to a computer and processed on said computer.

Referring to FIG. 4, this illustrates a typical ski slope 23 covered by snow on which a number of gates 24 are arranged around which the athlete 1 (not illustrated in FIG. 4) is intended to ski along an example track represented using a dotted line 25. In a preferred embodiment, next to at least one gate 24, permanent magnets 22 are buried in the snow. In another preferred embodiment the magnets 22 are integrated into the base of the gate 24. Circle 26 contains a magnified and more detailed view of one of the gates 8. The magnet 22 generates a local magnetic field 27.

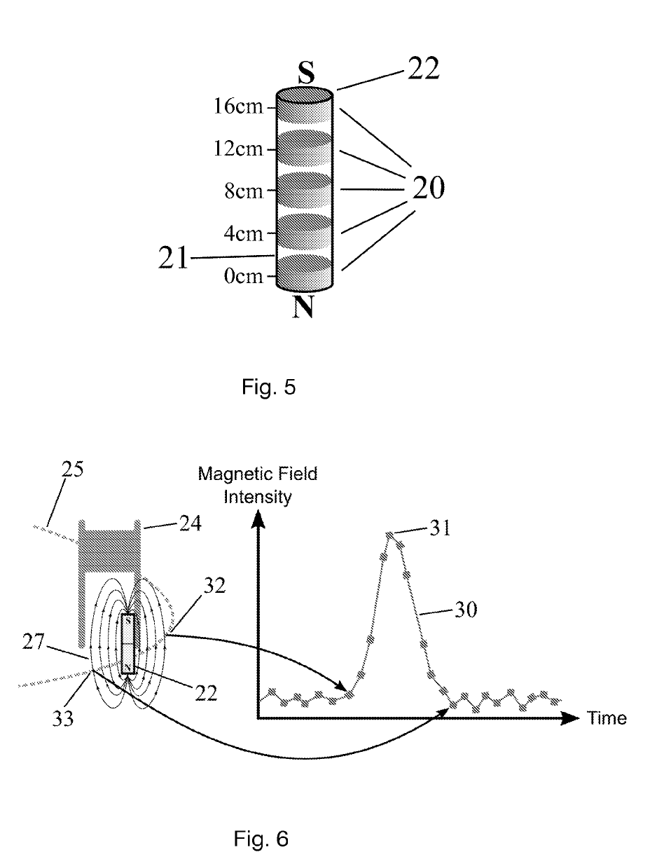

Referring to FIG. 5, this represents an example embodiment of the permanent magnet 22 placed next to the gates 24 as described in the previous paragraph. The final permanent magnet 22 is assembled from at least two smaller permanent magnets 20 where their individual magnetic fields are aligned. The magnets 20 may each be held in place by a plastic coating 21. The overall magnetic strength generated by the permanent magnet 22 must be sufficient to significantly disturb the Earth's magnetic field to distances of at least 0.5 m. This may be achieved by placing multiple small permanent magnets 20 in series where their N-S poles are aligned. The final magnetic field strength of permanent magnet 22 may be increased as desired by placing more small magnets 20 or by using stronger small magnets 20 such that its field can be sensed for distances of up to a few meters. In order to further increase magnetic field strength, the small permanent magnets 20 may be connected with short yokes made of iron (not represented in either FIG. 5). The small permanent magnets 20 may also simply be spaced by any object made from plastic or wood. In an alternative embodiment the permanent magnets 20 could also be directly integrated into a pole of a gate 24 such as the ones shown in FIG. 4.

Referring to FIG. 6, this illustrates a measured magnetic field intensity 30 measured with the magnetometer sensor unit 2 during a gate passage. The skiing trajectory 25 is around the gate 24 at a minimum distance small enough such that the magnetometer sensor unit 2 enters the local magnetic field 27 generated by the magnet 22 at a point 32 and exists such field at a point 33. At closest distance the measured magnetic field intensity 30 reaches a peak 31. In a preferred embodiment the magnetic field intensity is computed as the norm of the measured 3D magnetic field strength along each axis of the magnetic sensor 5.

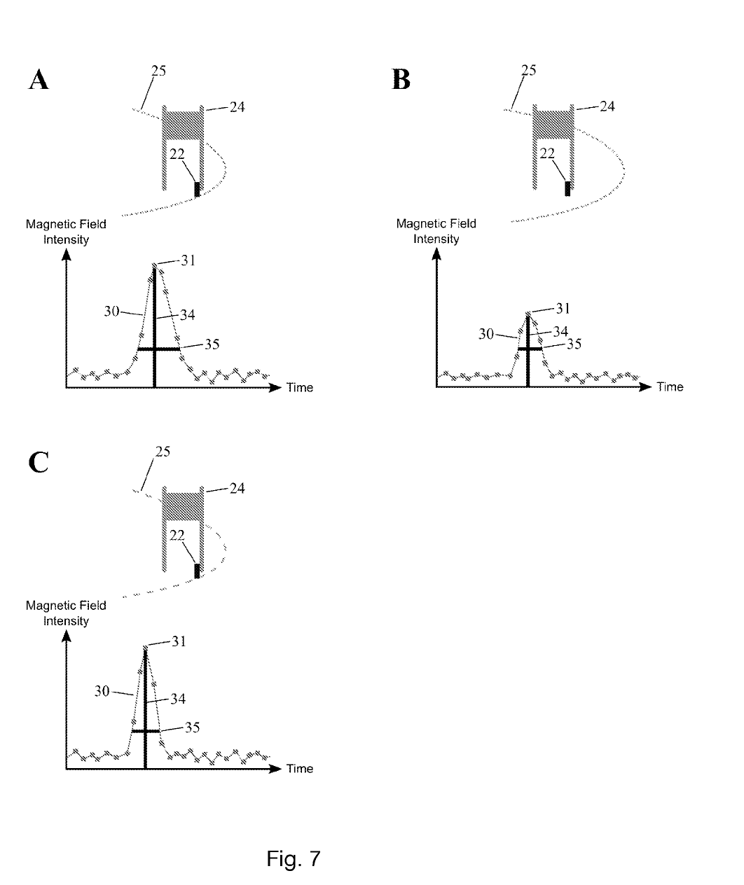

Referring to FIG. 7, this illustrates a schematic drawing of measured magnetic field intensity 30 for different means of gate passage. The gate 24 can be passed closely as in FIG. 7A or with a larger distance as in FIG. 7B. A physical gate contact is not required. Alternatively, the gate 24 can be passed with different speeds where FIG. 7A shows a slower speed and FIG. 7C shows a higher speed. In all cases the measured magnetic field 30 differs. The shape of the measured magnetic field changes where both peak height 34 and peak width 35 are influenced. Peak height 34 is inversely proportional to the distance between the magnetometer sensor unit 2 and the magnet 22; the closer the distance the higher the peak 34. Moreover, for larger distances the magnetometer sensor unit 2 is less long in the magnetic field 27 generated by permanent magnet 22; the closer the distance the larger the peak 35. The skiing speed influences mainly the peak width 35; higher speeds create a narrower peak shape. At high speeds, there might be no measured sample at the exact moment of closest distance. Thus the measured maximum peak 31 may be reduced compare to the true peak height.

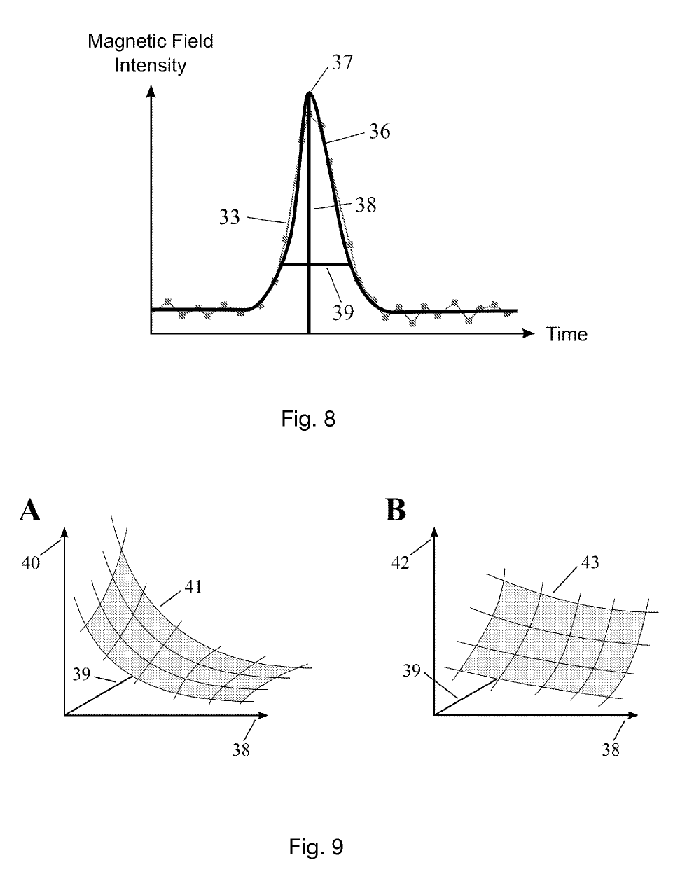

Referring to FIG. 8, this illustrates a curve 36 fitted to the measured magnetic field intensity 33. The curve fitting can be used for filtering out sensor noise and estimate true peak height. The fitted curve may have a different peak height 37, 38 than 34 and a different peak width 39 than 35. The curve 36 is fitted to 33 using standard curve fitting techniques such as for example a least square fitting or the fitting of a parametric curve such as a spline or the fitting of a template curve as used in pattern matching applications.

Referring to FIG. 9, this illustrates an example for the relationship between peak height 38, peak width 39 and distance and skiing speed at gate crossing. FIG. 9A illustrates the relationship between peak height 38, peak width 39 and distance 40. Surface 41 illustrates the best distance estimation. FIG. 9B illustrates the relationship between peak height, peak width and skiing speed. Surface 43 illustrates the best speed estimation The best fitting surfaces 41 and 43 can be found using machine learning techniques such as linear regression or neural networks and mathematical modelling, can be based on simulations, or mathematical models.

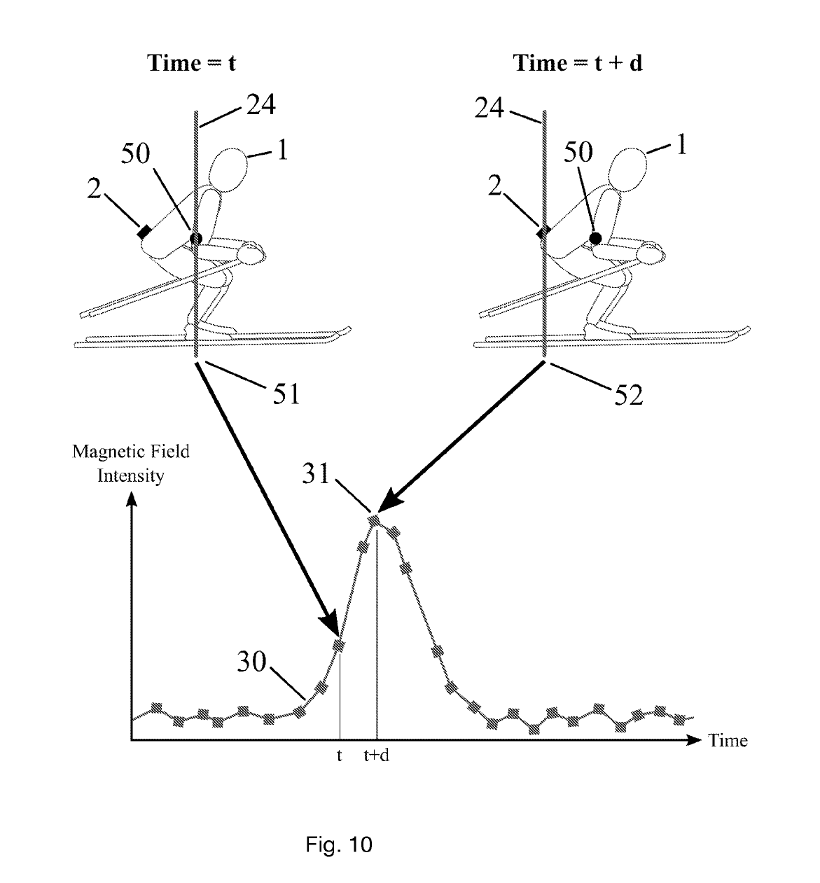

Referring to FIG. 10, this illustrates the time difference between gate passage of the athlete 1 center of mass 50 and the magnetometer sensor unit 2. Center of mass 50 and magnetometer sensor unit 2 are not aligned; the time of passing the gate 24 with the center of mass 50 is different from the time of passing gate 24 with the magnetometer sensor unit 2. Gate passage of the center of mass 50 is marked by 51. Gate passage of the magnetometer sensor unit 2 is marked by 52. The gate passage or relevance that needs to be estimated is the gate passage 51.

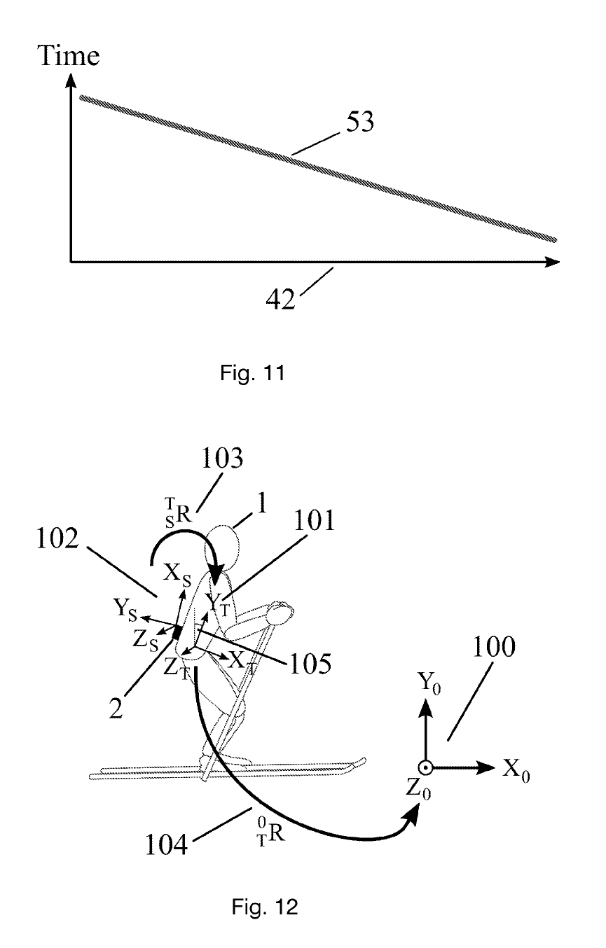

Referring to FIG. 11, this illustrates the time difference 54 between measured gate passage 52 and center of mass gate passage 51. The time difference is not constant but varies with skiing speed 42. The faster the speed, the shorter the time delay 53. In a simple embodiment this delay may be modelled to depend only on speed, thus the relationship between speed and delay is linear, following the law of physics where the distance s is the product between the speed v and time t: s=v*t. This relation is valid if a constant distance between center of mass 50 and magnetometer sensor unit 2 is assumed. However, since athlete 1 may change his posture between different turns the distance between center of mass 50 and magnetometer sensor unit 2 changes. Thus, in a preferred embodiment a more complex relationship taking into account at least one of the following parameters gate distance 40, gate crossing speed 41, trunk vertical inclination 105, trunk lateral inclination, turn radius 111.

In summary a preferred embodiment of the gate crossing invention is as follows. Magnets 22 are placed along the gates 24 of a skiing track 23. The athlete 1 wears a magnetometer sensor unit 2 and skis down the skiing track 23 along the trajectory 25. The magnetic fields 27 generated by magnets 22 is measured and magnetic field intensity 30 is computed. Peaks 31 are detected using a peak detection method and for each detected gate crossing a curve 36 is fitted to the magnetic field intensity 30. Next peak height 38 and width 39 are estimated. Knowing the previously computed relationships 41, 43 between peak height 38, peak width 39, and gate crossing distance 40 and speed 42, respectively, the gate crossing distance and skiing speed at gate crossing are estimated. Based on this estimates the time delay 53 between athlete center of mass 50 gate crossing 51 and magnetometer sensor unit crossing 52 is estimated and the true gate crossing time 51 is found.

Referring to FIG. 12, this illustrates the frames used for defining sensor and athlete orientation. The global frame 100 is fixed to the Earth and does not move over time. In a preferred implementation, for convenience one axis is parallel to Earth's gravity. The athlete's 1 lower trunk frame 101 is his anatomical frame of the lower trunk or the sacrum. This frame is fixed with respect to the athlete's lower trunk or sacrum. If the lower trunk or sacrum move, then this frame moves accordingly. The magnetometer sensor's frame 102 is the sensor frame of the magnetic sensor 5 and is fixed to the sensor. It moves with the sensor. In a preferred embodiment the magnetometer sensor 2 is rigidly fixed to the athlete (FIGS. 1 and 2), keeping the orientation difference between the sensor frame 102 and the athlete's frame 101 constant over time. This orientation difference is expressed with the 3×3 orientation matrix 103. The relation between the athlete's frame 101 and the global frame 100 changes over time. The orientation difference between the two frames is expressed with the 3×3 orientation matrix 104. This matrix specifies at the same time the orientation of the athlete's lower back. If 104 is known over time, then 101 is known over time. In a preferred embodiment Y_{T} is defined as the longitudinal axis of the trunk and Y₀ as the axis parallel to Earth gravity. The trunk inclination 105 is then defined as the angle between Y_{T} and Y₀. Such angle is computed, for example, using the vector product between Y_{T} and Y₀. The lateral trunk inclination (not shown on FIG. 12) is computed analogous and defined as the angle between Z_{T} and Z₀.

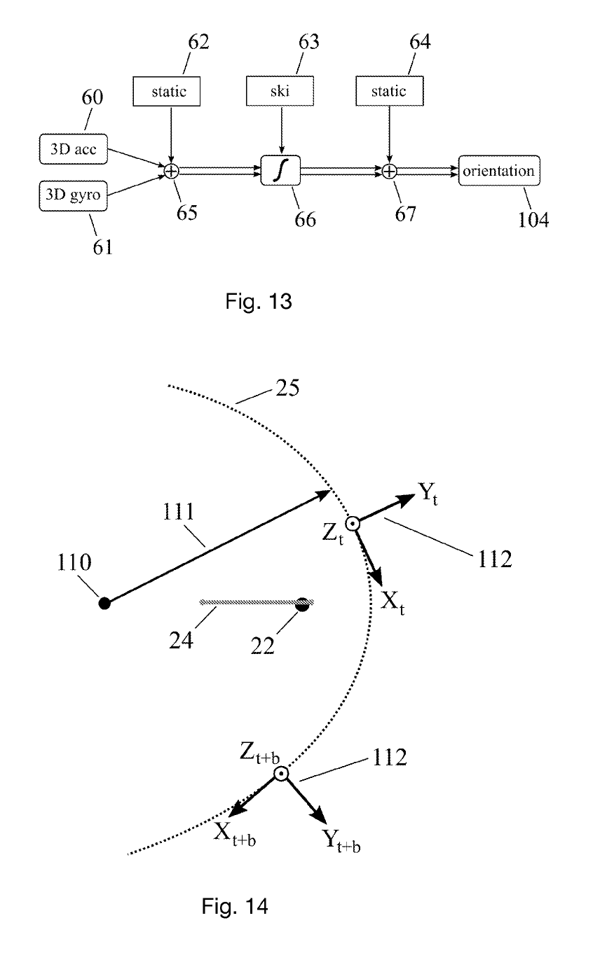

Referring to FIG. 13, this illustrates an example implementation of the strapdown integration procedure used to find the athlete's trunk orientation 104. In a preferred embodiment the orientation 103 of the magnetometer sensor unit 2 in the athlete's trunk frame 101 is known. This is for example achieved by aligning the sensor unit 2 with the trunk frame 101 when attaching the sensor unit 2 to the athlete 1. Alternatively, calibration movements are used to find 103. Matrix 103 is then used to express the measured accelerations and angular velocities in the trunk frame 101. From now on, 3D acceleration 60 and 3D angular velocity 61 are thus expressed in the trunk frame 101. A static posture 62 is used to find the initial parameters 65 for the strapdown integration 66 and to correct any gyroscope offsets. The strapdown integration 66 integrates the angular velocities in 3D to find the time-dependent orientation 104 during the period of the downhill skiing 63. At the end, the athlete performs again a static posture 64 and orientation drift can be corrected 67 in order to obtain a final orientation estimate 104.

Referring to FIG. 14, this illustrates an example skiing turn around gate 24 with magnet 22. Skiing trajectory of the athlete's center of mass 50 is marked by the dotted line 25. The trajectory around the gate can be locally approximated by a circle with center 110 and radius 111. This radius 111 is also defined as the turn radius. The skiing trajectory 25 is also used to define the trajectory frame 112. In a preferred embodiment its axes are defined as follows: Xₜ points in the forwards direction, tangential to the skiing trajectory 25. Zₜ points upwards and is perpendicular to the snow surface or to Y₀. Yₜ is the cross product between Zₜ and Xₜ. In a preferred embodiment the skiing radius 111 is estimated via the centripetal force defined as F=ma_{c}=mrω², thus

$$r = \frac{{a}_{c}}{{ω}^{2}}$$

where r is we skiing radius, a_{c} the centripetal acceleration, and ω the turn angular velocity. The centripetal acceleration is estimated based on the 3D acceleration 60 expressed in the frame 112. The turn angular velocity is estimated as based on the 3D angular velocity 61 expressed in the frame 112. In an alternative embodiment the skiing radius 111 can also be estimated using the relation

$$r = \frac{{v}^{2}}{{a}_{c}}$$

where v is the skiing speed 42. Since the athlete's center of mass 50 and the magnetometer sensor unit 2 are approximately on the same height but translated in the anterior-posterior direction (the athlete's center of mass 50 can be approximated to lie close to the athlete's belly button, whereas the magnetometer sensor unit 2 is on the sacrum) the trajectory in space of both points 50 and 2 are essentially the same except for the time lag that can be found using the relationship illustrated in 53. Thus, computations performed at the magnetometer sensor position 2 are valid also for the center of mass 50 when shifted in time accordingly.

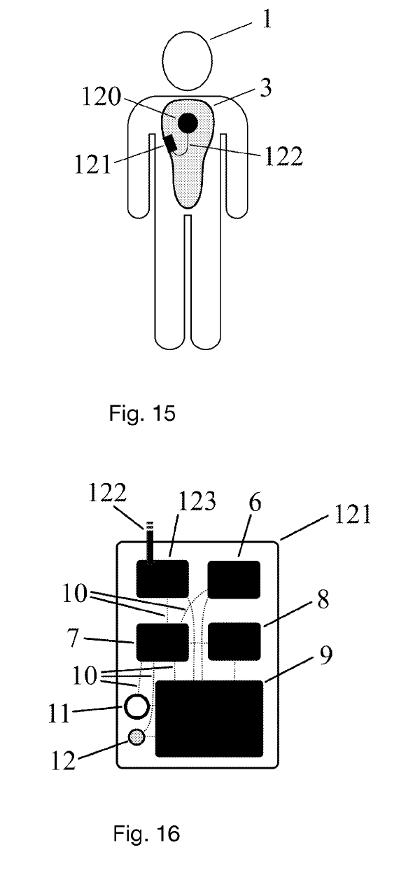

Referring to FIG. 15, this illustrates an example embodiment where the back protector 3 is instrumented with an active GNSS antenna 120 connected by a cable 122 to the GNSS sensor unit 121. In a preferred embodiment the GNSS sensor unit 121 can be spaced away from the GNSS antenna 120 to simplify the setup. The GNSS sensor unit 121 is controlling and powering the GNSS antenna 120 and recording, processing, and storing the GNSS signal In a preferred embodiment the GNSS antenna 120 is fixed in such a way that it lies between the shoulder blades of the athlete 1 at a time when the back protector 3 is worn. In an example embodiment the GNSS antenna is a Tallysman TW2710 with 10 cm ground plate.

Referring to FIG. 16, this illustrates an example embodiment of the GNSS sensor unit 121. The GNSS sensor unit 121 is composed of an inertial sensor measurement unit 6 measuring 3D acceleration and 3D angular velocity, a processing unit 7, a storage medium 8, a battery 9, an on/off button 11, and a LED 12. The different units are suitably connected by wires 10. Further, the GNSS sensor unit comprises a GNSS chip 123 with a connector for the GNSS antenna cable 122. The GNSS chip 123 is controlling and powering the GNSS antenna 120 and recording, processing, and storing the GNSS signal In a preferred embodiment the GNSS chip is a low-cost GNSS receiver, for example the u-Blox CAM-M8, providing navigation information computed from GPS and GLONASS satellite signals at 10 Hz. In another embodiment the GNSS receiver may be based on at least one of GPS, GLONASS, BeiDou, GALILEO, IRNSS, QZSS, DORIS signals In another embodiment, base stations for augmented signal quality, as for example differential GNSS are supplemented. In an example embodiment, navigation information computed by the GNSS chip 123 includes at least one of the following parameters: 3D position, 3D speed, speed norm, heading, 2D position, timestamp, DoP, speed accuracy, position accuracy, number of visible satellites, chip status, satellite orbits. In a preferred embodiment the acceleration and angular velocity are sampled at 500 Hz.

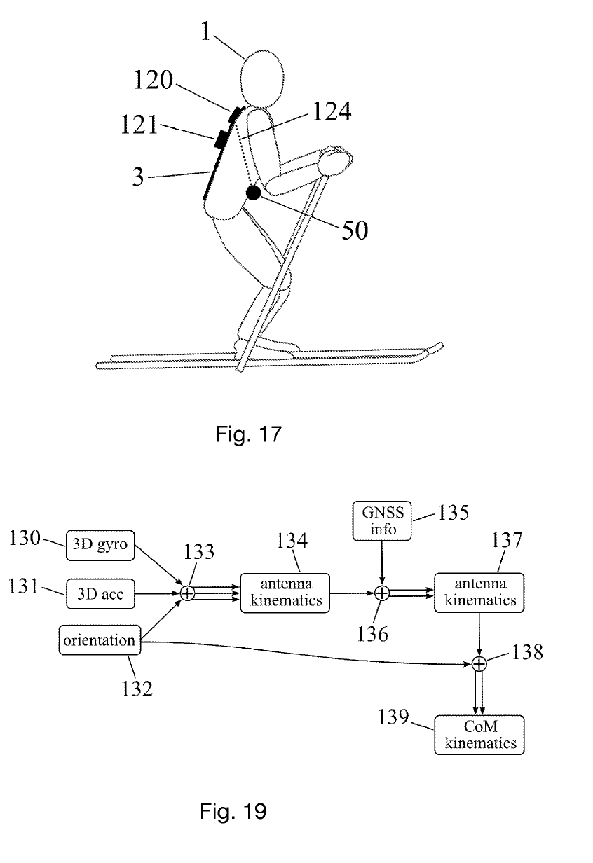

Referring to FIG. 17, this illustrates a schematic drawing of the athlete 1 viewed from the side. Athlete 1 is wearing the back protector 3 with GNSS sensor unit 121 and GNSS antenna 120. The athlete's center of mass 50 is not at the same position as the GNSS antenna 120. The center of mass is separated by distance 124 from the GNSS antenna. The distance 124 may change over time and depends on the athlete's posture.

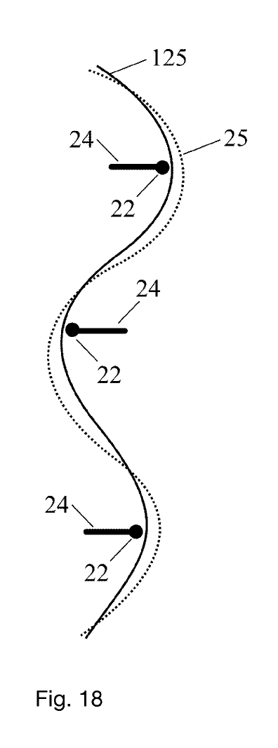

Referring to FIG. 18, this illustrates an example of the GNSS antenna trajectory 125 and of the center of mass trajectory 25 of the athlete 1 (not illustrated in this figure) skiing around the gates 24 with permanent magnets 22, viewed from the top. The athlete's pendular movement when he is inclining sideways his body to take the turn around each gate creates a significant offset between the two trajectories 125 and 25. Thus, the GNSS antenna trajectory needs to be altered to find the desired trajectory 25.

Referring to FIG. 19, this illustrates and example implementation of the estimation process for finding the athlete's center of mass trajectory 25. In a first step 3D angular velocity 130, 3D acceleration 131 and orientation 132 of the upper trunk are obtained as illustrated in FIG. 13 for the magnetic sensor unit. Denote the distance between the GNSS antenna 120 and GNSS sensor unit 121 as r_{imu-gnss}. In a preferred implementation r_{imu-gnss} is measured during the design process of the back protector 3 and remains constant over time. Based on Eq. 1 the acceleration is then translated 133 to the GNSS antenna position to obtain the kinematics 134 (acceleration, angular velocity, orientation) at the GNSS antenna.

\tilde{a}_{gnss}(t)=aᵢₘᵤ(t)+\dot{ω}ᵢₘᵤ(t)×r_{imu-gnss}+ωᵢₘᵤ(t)×(∫ᵢₘᵤ(t)×r_{imu-gnss}) Eq. 1

where ã_{gnss} is the calculated acceleration at the GNSS antenna, aᵢₘᵤ the acceleration measured at the inertial sensor 6 of GNSS sensor unit 121, ωᵢₘᵤ the angular velocity measured at the inertial sensor 6 of GNSS sensor unit 121, \dot{ω}ᵢₘᵤ the angular acceleration at the inertial sensor 6 of GNSS sensor unit 121, obtained by derivation of the angular velocity.

In the same step 133 the translated acceleration ã_{gnss} is transformed to the global frame 100, equivalent to the GNSS sensor frame and gravity is removed. This transform is performed based on Eq. 2.

^{GF}a_{gnss}(t)=_{LF}^{GF}R(t)*\tilde{a}_{gnss}(t)−^{GF}g Eq. 2

where ^{GF}a_{gnss} is the estimated, gravity-free acceleration at the GNSS antenna centre, _{LF}^{GF}R the orientation of the GNSS antenna with respect to the global frame, and ^{GF}g the Earth gravity.

The antenna kinematics 134 are sampled at the same sampling rate as the inertial sensor unit 6. In a preferred embodiment this sampling rate is 500 Hz. GNSS navigation information 135 is available at a sampling rate of 10 Hz. In a fusion process 136 the antenna kinematics 134 are fused with the GNSS navigation information 135. In a preferred embodiment a Kalman filter is fusing these two sources of information. Now, the antenna kinematics 137 are available at a 500 Hz sampling frequency and we do not only have 3D acceleration, angular velocity, and orientation but also 3D speed and 3D trajectory. In order to have sufficient spatial resolution it is important to have this data available at high sampling frequencies. For example, for a skiing speed of 80 km/h the skier travels approximately 22 m per second. Thus, at 10 Hz, we obtain one sample every 2m, which is clearly not sufficient during turns where the direction might change suddenly.

Finally, in 138 the antenna kinematics 137 are translated to the athlete's center of mass 50 using the trunk's orientation 132 and Eq. 1. In a preferred embodiment the athlete's center of mass 50 remains fixed with respect to the GNSS antenna 120. In another preferred embodiment the athlete's center of mass 50 is changing over time and the change of relative position to the GNSS antenna 120 is estimated based on the trunk orientation 132. For example for a higher trunk inclination 105 the center of mass 50 is lying more anterior to the trunk center. Now, the center of mass kinematics 139 are available at a high sampling rate, independent from the kinematics of the GNSS antenna 137.

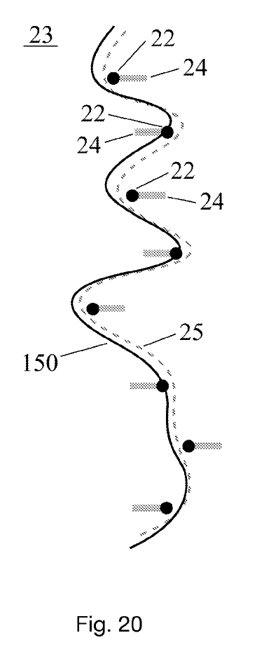

Referring to FIG. 20, this illustrates the ski slope 23 with gates 24 and magnets 22. The true skiing trajectory (i.e. athlete's center of mass trajectory) 25 is illustrated with the dotted line. However, as in a preferred embodiment a low-cost GNSS system is used, the estimated skiing trajectory (i.e. athlete's center of mass trajectory) 150 is perturbed by an error and may not match the true skiing trajectory 25. The estimated trajectory 150 is both affected by a constant and a time-varying offset both of which must be corrected in order to match the true trajectory 25 as closely as possible. In a preferred embodiment such difference is reduced to <0.1 m.

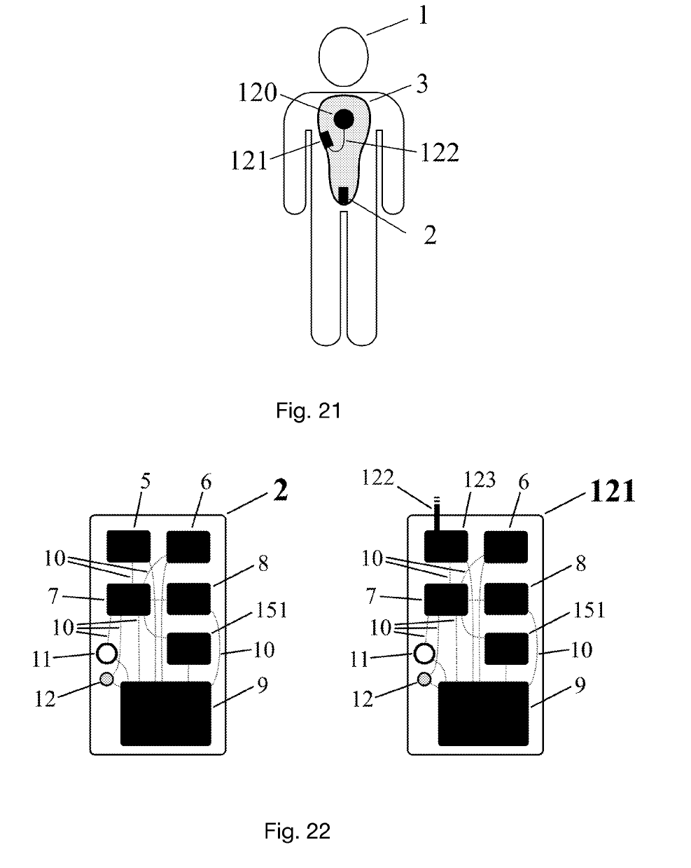

Referring to FIG. 21, this illustrates an example embodiment where both the magnetometer sensor unit 2 and GNSS sensor unit 121 are integrated in the back protector. The back protector 3 is further instrumented with an active GNSS antenna 120 connected by a cable 122 to the GNSS sensor unit 121. In a preferred embodiment the GNSS sensor unit 121 can be spaced away from the GNSS antenna 120 to simplify the setup. The GNSS sensor unit 121 is controlling and powering the GNSS antenna 120 and recording, processing, and storing the GNSS signal. In a preferred embodiment the GNSS antenna 120 is fixed in such a way that it is lies between the shoulder blades of the athlete 1 at a time when the back protector 3 is worn. In an example embodiment the GNSS antenna is a Tallysman TW2710 with 10 cm ground plate. In a preferred embodiment the magnetometer sensor unit 2 is fixed in such a way that it lies close to the sacrum of the athlete 1 at a time when the back protector 3 is worn.

Referring to FIG. 22, this illustrates and example embodiment of the magnetometer sensor unit 2 and the GNSS sensor unit 121. The magnetometer sensor unit 2 is composed of a magnetic sensor 5 measuring the 3D magnetic field, an inertial sensor measurement unit 6 measuring 3D acceleration and 3D angular velocity, a processing unit 7, a storage medium 8, a battery 9, an on/off button 11, and a LED 12 as described in FIG. 3. Additionally, the sensor unit 2 contains a module 151 capable of emitting and receiving electromagnetic signals used for synchronization with the GNSS sensor unit 121. The different units are suitably connected by wires 10. In an example embodiment the module 151 is a RF module with antennas for receiving and emitting an RF signal. The GNSS sensor unit 121 is essentially composed of the same components (6, 7, 8, 9, 10, 11, 12), see also FIG. 16. The magnetic sensor is replaced by a GNSS chip 123 with a connector for the GNSS antenna cable 122. The GNSS chip 123 is controlling and powering the GNSS antenna 120 and recording, processing, and storing the GNSS signal. In a preferred embodiment the GNSS chip is a low-cost GNSS receiver, for example the u-Blox CAM-M8, providing navigation information computed from GPS and GLONASS satellite signals at 10 Hz. In another embodiment the GNSS receiver may be based on at least one of GPS, GLONASS, BeiDou, GALILEO, IRNSS, QZSS, DORIS signals In another embodiment, base stations for augmented signal quality, as for example for differential GNSS are be supplemented. In an example embodiment, navigation information computed by the GNSS chip 123 includes at least one of the following parameters: 3D position, 3D speed, speed norm, heading, 2D position, timestamp, DoP, speed accuracy, position accuracy, number of visible satellites, chip status, satellite orbits. In a preferred embodiment the acceleration and angular velocity are sampled at 500 Hz.

In a preferred embodiment the magnetometer sensor unit 2 is wirelessly synchronized with the GNSS sensor unit 121 using the RF modules 151. In one example implementation one sensor unit acts as a master unit and emits a RF pulse at regular intervals. At the same time, the timestamps of each emitted unit is stored on its storage medium 8. The other unit, denoted as a slave unit, receives the RF pulses and can use their timestamps to stay in synchronization with the master unit. In a preferred embodiment the synchronization can be implemented on the processing unit 7. In another embodiment the synchronization pulses are recorded on the storage medium 8 and synchronization is performed offline. In an example embodiment the LED 12 of both units are blinking synchronously if the slave unit is in sync with the master unit. Such synchronization is essential for the later steps when information from both sensor units 2 and 121 is fused.

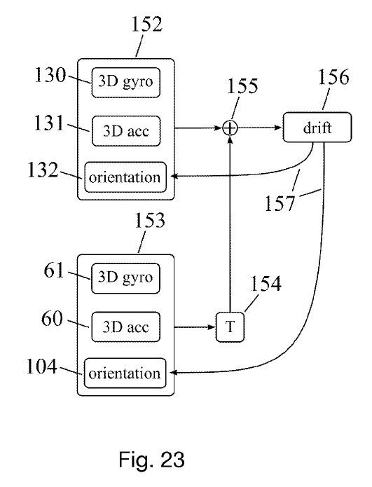

Referring to FIG. 23, this illustrates an example embodiment where both inertial sensor units 6 in the magnetometer sensor unit 2 and GNSS sensor unit 121 are used to estimate any remaining drift from the strapdown integration procedure (FIG. 13) and in turn to update and correct the orientation estimation of each sensor. This updated information is then used as described previously to estimate a more precise skiing trajectory 25 and gate passing times. In a preferred embodiment the drift is estimated as follows. Let denote the measured acceleration 60, angular velocity 61 and estimated orientation 104 of the magnetometer sensor unit 2 as the sacrum IMU data 153. Let denote the measured acceleration 130, angular velocity 131 and estimated orientation 132 of the GNSS sensor unit 121 as the GNSS IMU data 152. Sacrum IMU data, especially acceleration 60, 153 is transformed to the GNSS sensor location using Eq. 1. In an example embodiment the distance between both sensor units 2 and 121 has been measured during sensor placement in the back protector 3. In comparator and estimator 155 the IMU information 152 and translated IMU information 153 are compared. In a first step, acceleration and angular velocity data from 152 and transformed 153 are transformed in a common frame. In a preferred embodiment this frame is the global frame 100. If no drift were present acceleration vectors from both sensors match. Denote the acceleration from the sacrum IMU as ^{GF}a_{sacrum}(t) Denote the acceleration from the GNSS IMU as ^{GF}a_{gnss} (t). Any drift present introduces a difference in vector direction between both acceleration vectors, i.e.

$$\frac{{{}_{}^{GF}{a}{}_{sacrum}^{}}_{} ( t ) \cdot {}_{}^{GF}{a}{}_{gnss}^{} ( t )}{\vert {}_{}^{GF}{a}{}_{sacrum}^{} ( t ) \vert \cdot \vert {}_{}^{GF}{a}{}_{gnss}^{} ( t ) \vert} \neq 1.$$

This difference is defined as the drift 8(t). In quaternion notation it is estimated based on Eqs. 3-5.

$$δ ( t ) = [ cos ( \frac{β ( t )}{2} ) , sin ( \frac{β ( t )}{2} ) \cdot U ( t ) ] \qquad Eq . 3$$

where β(t) and U(t) are the axis-angle representation of δ(t) (Eqs. 4-5):

$$\begin{matrix}β ( t ) = acos ( \frac{{}_{}^{GF}{a}{}_{{ }_{sacrum}}^{} ( t ) \cdot {}_{}^{GF}{a}{}_{gnss}^{} ( t )}{\vert {}_{}^{GF}{a}{}_{sacrum}^{} ( t ) \vert \cdot \vert {}_{}^{GF}{a}{}_{gnss}^{} ( t ) \vert} ) & Eq . 4 \\ U ( t ) = \frac{{{}_{}^{GF}{a}{}_{sacrum}^{}}_{} ( t ) {\times }^{GF} {a}_{gnss} ( t )}{\vert {}_{}^{GF}{a}{}_{sacrum}^{} ( t ) \times {}_{}^{GF}{a}{}_{gnss}^{} ( t ) \vert} & Eq . 5\end{matrix}$$

In a preferred embodiment, the final drift estimate 156 for each sample t is defined as the average quaternion (i.e. average orientation) of all available drift estimates in the interval [t−1.25 sec; t+1.25 sec].

Due to sensor noise not all time samples t are suitable for obtaining a reliable drift estimate. Thus, samples where either ^{GF}a_{sacrum}(t) or ^{GF}a_{gnss}(t) are below a fixed threshold samples where their difference are above a certain thresholds are not considered for drift estimation. In a preferred embodiment such thresholds are 8 m/s² and 2.5 m/s², respectively. Finally the drift is separated into two and corrected recursively 157 for each IMU orientation 132 and 104.

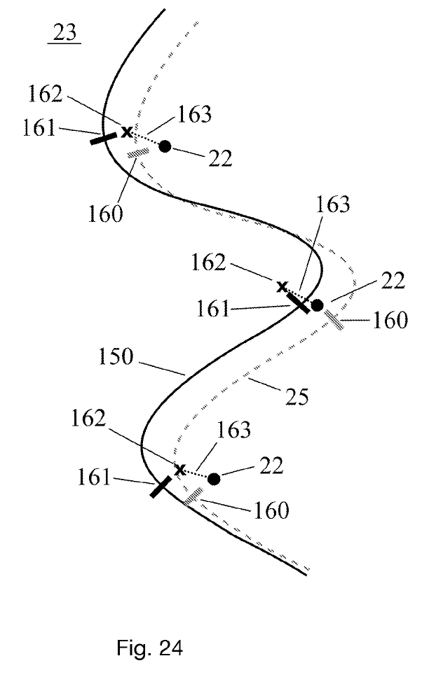

Referring to FIG. 24, a zoom on the ski slope 23 is illustrated. Permanent magnets 22 are placed at each gate (not shown in this figure for clarity). The true skiing trajectory (i.e. athlete center of mass trajectory) 25 is indicated by the dashed line. The solid line marks the estimated skiing trajectory 150 which is offset with respect to the true skiing trajectory 25. The detected gate passages are marked with perpendicular black lines 161. The true gate passages are marked with the perpendicular gray lines 160. Estimating gate passage distance 40 at each gate allows reconstructing the permanent magnet's position 162. The magnet position error 163 is then estimated knowing the true magnet position 22 by subtracting the estimated position 162 from the true position 22.

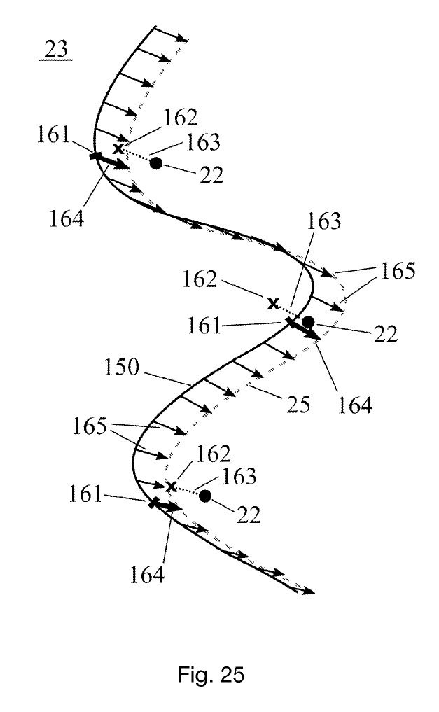

Referring to FIG. 25, this illustrates a preferred embodiment for correcting the skiing trajectory error. Illustrated is again the skiing slope 23 with magnets 22 placed at each gate (not shown in this figure for clarity). The true skiing trajectory (i.e. athlete center of mass trajectory) 25 is indicated by the dashed line. The solid line marks the estimated skiing trajectory 150 which is offset with respect to the true skiing trajectory 25. The detected gate passages are marked with perpendicular black lines 161. Estimating gate passage distance 40 at each gate allows reconstructing the permanent magnet's position 162 and finding the magnet position error 163. At each gate passage this error 163 is used to define the trajectory shifting vector 164. Next, in a preferred embodiment interpolated trajectory shifting vectors 165 are computed by linear or non-linear interpolation between each trajectory shifting vector 164. The final skiing trajectory is computed by shifting each position sample by its corresponding shifting vector. In another embodiment Kalman filters or other more advanced filters (e.g. non-linear filters, particle filters) are used to fuse the gate position errors 163 with the trajectory 150 to obtain a precise estimate of the true skiing trajectory 25.

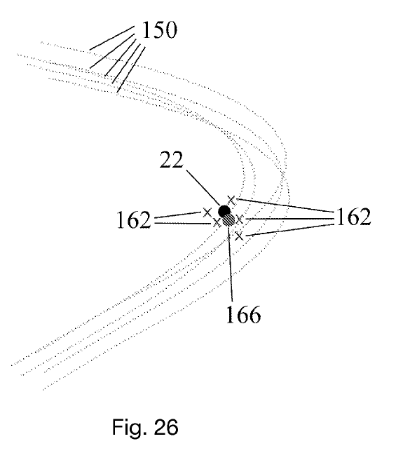

Referring to FIG. 26, this illustrates a zoomed view of one turn. The permanent magnet 22 is placed at the gate (not shown in this figure for clarity). In an example embodiment at least one athlete skis the run at least twice. In a preferred embodiment the skiing trajectories 150 were estimated using the methods explained above. Because of the GNSS errors and small differences in the true skiing trajectories 25 (not shown in this figure) the trajectories 150 do not match. For each gate passage the magnet positions 162 are estimated. On the assumption of independent errors between runs, the magnet positions 162 are normally distributed around the true magnet position 22. In a preferred embodiment the true magnet position 166 is estimated as the average of all estimated positions 162. The estimated true magnet position 166 is now used as input magnet positions for computing corrected skiing trajectories 150 according to the method described previously. In another embodiment the magnet positions 22 are estimated with traditional surveying technologies or with 3D terrain models of the ski slope obtained from aerial imagery. In a preferred embodiment the software solution from Pix4D is used to construct the terrain model.

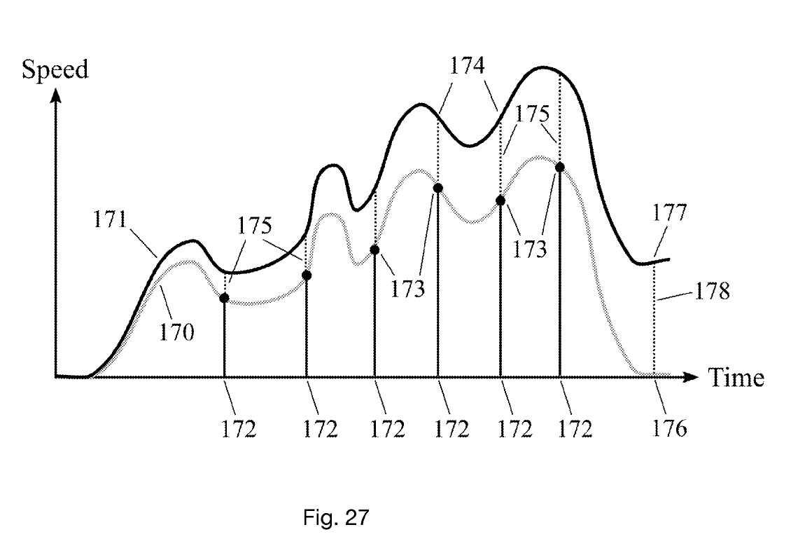

Referring to FIG. 27, this illustrates a preferred embodiment where only the magnetometer sensor unit is used to estimate the skiing speed 170 and in a second step skiing trajectory 150. In a preferred embodiment measured acceleration at the sensor is first expressed in the global frame and the gravity is removed (Eq. 2). Then, this acceleration is integrated along each axis. Because of small measurement errors drift accumulates and affects the speed estimation 171 is an example illustration of the norm of the speed obtained after integrating the acceleration. Gate passages are detected 172 and for each passage the true speed is estimated 173 as explained previously. By comparing this speed 173 to the speed obtained from integration 174 the speed error 175 is obtained. This speed error is defined to match the drift. Next, linear or non-linear interpolation (such as spline interpolation) is used to compute the drift at each sample. For the last part of the race the zero speed at race end 176 is used: when the athlete has stopped at the end of the run the speed must be zero. Thus, the speed 177 equals the speed error 178 and is added to the drift correction. Once the drift for each sample is computed it is subtracted from each sample and a drift free speed estimate is obtained for the entire race without the need of using a GNSS sensor unit 121. To obtain the skiing trajectory 150 this speed is again integrated. This method provides thus an alternative means to compute the skiing trajectory 150 when the GNSS sensor is not to be used.

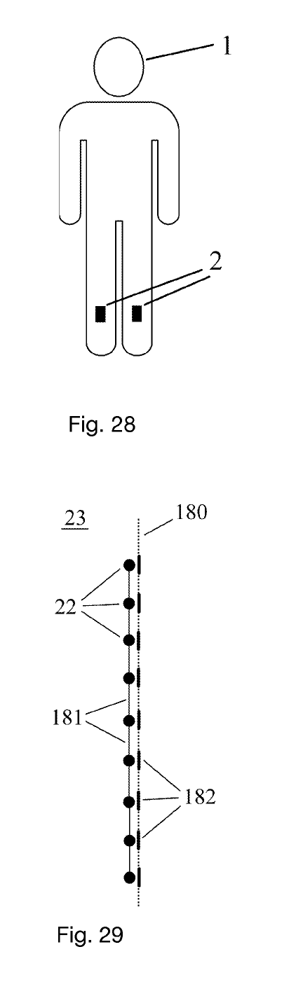

Referring to FIG. 28, this illustrates another embodiment where at least one magnetic sensor units 2 is placed on the left or right shank of the athlete 1.

Referring to FIG. 29, this illustrates the situation for gliding tests. The athlete 1 (not shown on the figure) is skiing along a straight line 180 on the ski slope 23. The permanent magnets 22 are placed at regular intervals 181 along the straight line. In a preferred embodiment the magnet passages are recorded by the magnetic sensor 2 placed on the shank or sacrum. To guide the athlete 1 along the straight line markings 182 are placed on the snow next to the magnets 22. In a preferred embodiment the athlete 1 is skiing over the buried magnets 22, i.e. the skiing line 180 matches line connecting all magnets 22. The timing difference between each subsequent detected magnet passage is used to construct the skiing speed profile and is used for evaluation of the skiing performance, for example when testing different skis.

1-19. (canceled)

20. A method for contactlessly determining a passage of an athlete at a plurality of points along a track, the athlete being equipped with a wearable magnetometer sensor unit having a magnetic sensor, at each point a permanent magnet is located at or in proximity of the track, the method comprises the steps of:
recording a signal with the magnetic sensor;
detecting a disturbance of a local magnetic field generated by passing by a permanent magnet in the recorded signal and measuring the disturbance with a processing unit;
mapping of the measured disturbance to a movement speed of the athlete and a distance between the athlete and the permanent magnet corresponding to the local magnetic field by the processing unit; and
correcting the movement speed and the distance by the processing unit for a time offset between a passage of the athlete at the permanent magnet and the magnetometer sensor unit.

21. The method of claim 20, wherein the magnetometer sensor unit is fixed to a trunk of the athlete and further includes a 3D accelerometer and 3D gyroscope, the method further comprising the steps of:
measuring 3D accelerations and 3D angular velocities at the magnetometer sensor unit;
computing a trunk orientation based on the measured 3D accelerations and 3D angular velocities; and
using the trunk orientation to report the measured 3D acceleration and 3D angular velocities in a global reference frame, to remove a gravity of earth from the measured acceleration, and to estimate a turn radius and to provide data expressing the measured quantities along the trajectory frame.

22. The method of claim 21, further comprising the step of:
calculating a speed by integrating the 3D acceleration; and
correcting a speed drift based on the calculated speed at point passage and at beginning and end of the passage of the athlete along the track.

23. The method of claim 22, further comprising the step of
integrating the speed to obtain a movement trajectory.

24. The method of claim 20, wherein the permanent magnets are placed at gates along a skiing race track, each permanent magnet integrated in a pole of the respective gates.

25. The method of claim 20, wherein the permanent magnets are placed at gates along a skiing race track on or buried in snow.

26. The method of claim 20, wherein the permanent magnets are placed at regular intervals along a marked line on the track.

27. The method of claim 20, wherein each permanent magnet includes two smaller permanent magnets spaced apart by an iron yoke or a non-magnetic spacing material.

28. The method of claim 20, wherein the magnetometer sensor unit further includes a communication device for transmitting recorded data wirelessly to a base station.

29. A method for determining a skiing trajectory of an athlete, the skiing trajectory defined as a trajectory of the athlete, the athlete equipped with an instrumented back protector, the back protector including
an active Global Navigation Satellite System (GNSS) antenna, the GNSS antenna arranged at the back protector such that the GNSS antenna is located between shoulder blades of the athlete when the back protector is worn,
GNSS sensor unit having a global navigation satellite system receiver, an inertial sensor unit with 3D accelerometers and 3D gyroscopes, a processing unit, and a storage medium,
wherein the method comprises the steps of:
computing a trunk orientation based on measured 3D accelerations and 3D angular velocities;
translating the measured 3D accelerations and 3D angular velocities to a GNSS antenna position and expressing the GNSS antenna positions in a global reference frame;
removing a gravity of earth from the measured acceleration to obtain inertial measurement unit-derived antenna kinematics;
fusing the inertial measurement unit-derived antenna kinematics with navigation information from the GNSS receiver to obtain final antenna kinematics, including at least one of acceleration, speed, position, angular velocity, and orientation; and
translating the antenna kinematics to the athlete to obtain the final kinematics.

30. The method of claim 29, wherein the athlete further wears a magnetometer sensor unit including a magnetic sensor, and
wherein the GNSS sensor unit further includes a synchronization module to achieve a sample-by-sample electronic and automatic synchronization between the GNSS sensor unit and the magnetometer sensor unit, one of the GNSS sensor unit and the magnetometer unit acting as a master unit and the other one as a slave unit, and emitting a synchronization signal in regular intervals, the synchronization signal being received, processed and recorded by the slave unit to synchronize an internal clock with the master unit.

31. The method of claim 30, further comprising
translating the measured inertial data of at least one of the GNSS sensor unit and the magnetometer sensor unit to the other unit,
comparing inertial data from each sensor unit in a common reference frame to determine differences,
relating the differences to an orientation estimation drift, and
correcting orientation estimation drift in both sensor units in a recursive or iterative manner.

32. The method of claim 30, further comprising the steps of:
improving a precision of the skiing trajectory estimated with the GNSS system by
estimating a magnet position of each passed permanent magnet,
comparing the estimated magnet positions with true magnet positions, obtaining an initial trajectory estimation error for each magnet, from a result of the comparing, and
interpolating between each estimation error and subtraction of an error curve from the initial trajectory estimation to obtain a precision improved skiing trajectory estimation.

33. The method of claim 32, further comprising the step of
estimating the true magnet positions of the permanent magnets based on averaging estimated magnet position from a plurality of passages.

34. The method of claim 31, wherein the GNSS sensor unit further includes a communication device for transmitting recorded data wirelessly to a base station.

35. A system configured to contactlessly determine an exact passage of an athlete at points placed along a track, the system comprising:
a gearing to be worn by the athlete, the gearing including a wearable magnetometer sensor unit including a magnetic sensor;
a processing unit in communication with the wearable magnetometer sensor unit, the processing unit having a storage unit; and
permanent magnets located at each point at or in proximity of the track;
wherein the processing unit is configured to
when the athlete moves along the track, record a signal in the storage unit to detect, for each permanent magnet, a disturbance of a local magnetic field generated by the permanent magnet in the recorded signal and to measure the disturbance,
map the measured disturbance to a movement speed of the athlete and a distance between the athlete and the magnet corresponding to the local magnetic field, and
correct the movement speed and the distance for a time offset between the magnet passage of the athlete and the magnetometer sensor unit.

36. The system of claim 35, wherein the magnetometer sensor unit further includes a 3D accelerometer and 3D gyroscope, wherein the magnetometer sensor unit is further configured to
measure 3D accelerations and 3D angular velocities, and
compute a trunk orientation based on the measured 3D accelerations and 3D angular velocities, by using the trunk orientation to report the measured 3D acceleration and 3D angular velocities in a global reference frame, to remove a gravity of earth from the measured acceleration, and to estimate a turn radius and to provide data to express the measured quantities along the trajectory frame.

37. The system of claim 35, wherein the gearing includes the processing unit.

38. The system of claim 35, wherein the processing unit is separate from the hearing and is in wireless communication with the gearing.

39. The method of claim 20, wherein the passage of the athlete is determined by a center of mass of the athlete.
